(19) United States
(12) Patent Application Publication
(10) Pub. No.: US 2009/0271838 A1
(43) Pub. Date: Oct. 29, 2009

(54) METHOD FOR TRANSMITTING SCENE DATA IN A UNIDIRECTIONAL DATA BROADCAST SYSTEM

(76) Inventors: Jorg Heuer, Oberhaching (DE); Andreas Hutter, Munchen (DE)

Correspondence Address: STAAS & HALSEY LLP, SUITE 700, 1201 NEW YORK AVENUE, N.W., WASHINGTON, DC, 20005, US

(21) Appl. No.: 12/312,229

(22) PCT Filed: Oct. 26, 2007
(86) PCT No.: PCT/EP2007/061519

§ 371 Date: Apr. 30, 2009

(30) Foreign Application Priority Data
Oct. 31, 2006 (DE) 10-2006-051-438.6
Jun. 5, 2007 (DE) 10-2007-026-222.3

(51) Int. Cl. H04N 7/173

(52) U.S. Cl. 725/114; 709/231

(57) ABSTRACT

A plurality of scene data describing at least one scene are transmitted by a data carousel from a transmitter to at least one receiver of a unidirectional broadcast system. The data carousel is used to transmit an index file to the receiver, a temporal arrangement of the scene data file being encoded in terms of data systems in the index file, to graphically represent and/or decode the scene.

### CROSS REFERENCE TO RELATED APPLICATIONS

This application is a U.S. national stage of International Application No. PCT/EP2007/061519, filed Oct. 26, 2007 and claims the benefit thereof. The International Application claims the benefits of German Application No. 10 2006 051 438.6 filed on Oct. 31, 2006 and German Application No. 10 2007 026 222.3 filed on Jun. 5, 2007, all three applications are incorporated by reference herein in their entirety.

### BACKGROUND

The method relates to the field of communications engineering and to the transmission of scene data in a unidirectional data broadcast system by a data carousel.

In unidirectional data broadcast systems data is transmitted from a transmitter to one or more receiver(s) using the push method. In broadcast systems data is transmitted, in particular in streaming methods, as continuous data streams, and this has the advantage that high data rate accuracy requirements can be fulfilled if, for example, the data rate is coupled to the system clock of the receiver. Therefore audio and video data streams are currently generally streamed to the receivers, the data in each case being provided with time markers which indicate at which times they are relevant to a presentation and/or decoding. One drawback of the streaming method is that the receivers cannot have missed or imperfectly received data transmitted again.

Data transmission by way of the download method is also known in broadcast systems in which data is transmitted from the transmitter to the receivers in the form of data files or data objects and are stored in the receiver. Previously only supplementary data relating to audio and video data streams of the same data transmitted session, such as electronic program information (EPG=Electronic Program Guide) and the like, have been transmitted to the receivers using the download method. The reason for this is that supplementary data of this kind are not time-critical, so it is not necessary to synchronize these supplementary data for presentation with the audio and video data streams transmitted using the streaming method.

However, this situation has fundamentally changed in the field of what are known as rich media applications, in which graphics scenes are described. Each graphics scene, which can be applicable for a relatively long period, is composed in these applications of audio, video and scene data (graphics and text data) (see for example MPEG standard “LASer” (Lightweight Application Scene Representation), formerly called MPEG 4, Part 20, or ISO/IEC 14496-20, which specifies a format for describing graphics scenes). As the state of a scene described by the scene data is time-critical it is necessary to synchronize the scene data with the audio and video data streams.

If data is transmitted between transmitter and receiver by point-to-point connections, the scene and media data (audio and video data) can be streamed to the receiver simultaneousy, so they are available to the receiver at the start of the period in which they are applicable. As the broadcast method cannot ensure that a receiver receives the data stream as early as at the start of the period in which a respective scene is applicable however, it is necessary, at least during the period of applicability of a scene, to transmit the scene data again and again, so a receiver, which only switches on later, can also receive the scene data. The scene can include a plurality of scene data files, or scene objects contained in the scene data files, in this connection, the allocation—which of these scene data files or scene objects belongs to a specific scene—only being visible via an interpretation of the scene or what is known as the root element of the directory structure. Simple caching or parsing of the scene data files or scene objects is therefore not possible without an interpretation of the scene. Caching of the scene data files, or scene objects relating to the scene, which are used in several scenes, is not possible either.

One approach to solving this problem has previously only been known via the standard, specified by the international DVB project (DVB=Digital Video Broadcasting) of the EBU (EBU=European Broadcasting Union), “Multimedia Home Platform” (MHP=Multi Media Home Platform) in which transmitting and representation of interactive contents is standardized on the basis of the programming language Java. In the current version of this standard, MHP v1.1, the relatedness of application objects can be signalled by a directory structure. Signalling of how long objects should be cached for, or synchronization of scene states, is achieved in MHP v.1.1 in that time markers of the audio and video data streams are referenced in the scene data of the scene to be described.

In principle the transport protocol RFC 3926 “Flute” (Flute=File Delivery over Unidirectional Transport), standardized by the IETF (Internet Engineering Task Force), makes it possible to group data files. However, the grouping therein only indicates that the files should only be passed to the application when all files of a group have been received.

In the previous solutions there is therefore no signalling of the content, of how long scene data files or scene objects should be cached for, there is no possibility of using scene data files or scene objects in several scenes and there is no identification of scene files or scene objects which belong to the same scene.

### SUMMARY

By contrast, the method described below for unidirectional transmission of scene data files or scene objects describing a scene uses the push method, between a transmitter and one or more receiver(s), with which it is possible to signal when and/or how long scene data files or scene objects should be cached. Thus, it is possible to use scene data files or scene objects in several scenes, and the method allows for identification of scene data files or scene objects which belong to the same scene.

A method for transmitting a plurality of scene data files describing at least one scene in a unidirectional data broadcast system is disclosed where the data broadcast system includes a transmitter for transmitting the scene data files, and at least one receiver. The unidirectional data broadcast system can be a broadcast, multicast or unicast data broadcast system.

In the unidirectional data broadcast system the scene data files are sent to the receiver by a data carousel which is capable of transmitting scene data files, or scene data objects contained in the scene data files, in cyclical repetition to the at least one receiver. The data carousel is constructed in the form of what is known as a data object carousel and is therefore capable of repeatedly transmitting not only files, but also directory structures, cyclically. Data or data object carousels for cyclically repeated sending of data is specified as such for example in the DSM-CC standard (DSM-CC=Data Storage Media Command and Control) and are therefore well known to the relevant experts, so further explanation is superfluous here. Data carousels can also be based on Flute and/or ALC (Asynchronous Layer Coding) and/or LCT (Layer Coding Transport).

A fundamental feature of the method lies in the fact that the data carousel contains an index file which is transmitted to the at least one receiver, a temporal arrangement of the scene data files, or the scene data objects contained therein, being encoded in terms of data systems in the index file in order to graphically represent (presentation) and/or decode the scene.

The index file transmitted to the at least one receiver therefore indicates the information as to which scene data files, or scene data objects contained therein, are required in a specific period for a presentation or decoding, so caching of the scene data files can be controlled by the receiver, without prior interpretation of the scenes, solely on the basis of the index file. In particular, scene data files, or the scene data objects contained therein, can be reused without re-loading.

In an advantageous development of the method a start time to graphically represent and/or decode the scene is encoded in terms of data systems in the index file. This advantageously allows caching of scene data files, or the scene data objects contained therein, to be coordinated in relation to a start point of a scene to be represented and/or decoded.

In a further advantageous development of the method, encoded in terms of data systems in the index file is the scene data file which contains a root element for a directory structure of the scene, so this information can also advantageously be used for caching the scene data files before presentation and/or decoding of the scene.

In a further advantageous development of the method, encoded in terms of data systems in the index file is the information about the time by which all scene data files are to be cached in the receiver, so all scene data files, or scene data objects contained therein, describing this scene are advantageously present in the receiver by the start time of graphical representation and/or decoding of a scene described in the scene data files.

In a further advantageous development of the method, encoded in terms of data systems in the index file is the information about the time by which the scene data files are to be left in what is known as a rendering tree and/or shadow tree (see SVG 1.2 W3C Working Draft 29.4.2003) used for graphical representation, so scene data files, or scene data objects contained therein, can advantageously be deleted in the receiver if they are no longer required, or can continue to be stored if repeated use is envisaged.

In a further advantageous development of the method the index file is based on the FDT (FDT=File Delivery Table) of a flute data transmission session, so the flute data carousel advantageously has to be checked less frequently following updates.

In a further advantageous development of the method the index file contains at least one identifier which identifies at least one scene. The index file thus allows identification of a scene for external referencing, and this has the advantage that the scene can also be referred to externally.

In a further advantageous development of the method the index file contains scene data file references to external resources. Examples of such references are URIs (URI=Uniform Resource Identifier) or URLs (URL=Uniform Resource Locator). The index file is therefore also used here to index resources referenced in the scene, for example audio and/or video data streams or data files or data objects. This has the advantage that a scene does not have to be interpreted to determine which set of data files or data objects is required for the scene. In other words, it can be determined without importing scene data files whether all resources required to represent and/or decode a scene have already been received in the receiver.

The unidirectional data broadcast system includes a transmitter and at least one receiver, transmitter and receiver being suitably constructed for carrying out a method as described above.

The transmitter of a unidirectional data broadcast system as described above in which a processor executes machine-readable program code which contains control commands that cause the transmitter to carry out a method as described above. A storage medium (computer program product) may store the machine-readable program code required to perform the method.

The receiver of a unidirectional data broadcast system, as described above, in which a processor executes machine-readable program code which contains control commands which cause the receiver to carry out a method as described above. A storage medium (computer program product) may store the machine-readable program code required to perform the method.

### BRIEF DESCRIPTION OF THE DRAWINGS

These and other aspects and advantages will become more apparent and more readily appreciated from the following description of an embodiment, taken in conjunction with the accompanying drawings of which:

FIG. 1 is a block diagram of an exemplary embodiment of a unidirectional data broadcast system to illustrate an exemplary embodiment of the method.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

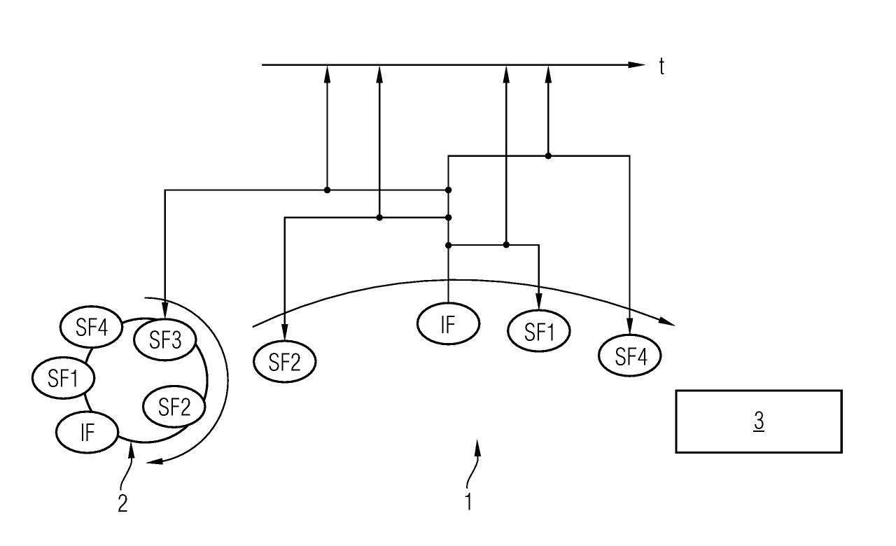

FIG. 1 shows an exemplary embodiment, designated as a whole by reference numeral 1, for the unidirectional data broadcast system. The data broadcast system 1 includes a transmitter 2 and a plurality of receivers 3, of which only one is shown in FIG. 1. Data is transmitted between transmitter 2 and receivers 3 using the broadcast method, i.e. sent from the receiver 2 to the receivers 3 using the push method. Data transmission can be wireless or wired, and this is not shown in more detail in FIG. 1.

The transmitter 2 sends data files by a data carousel or data object carousel to the receiver 3. The data carousel or data object carousel of the transmitter 2, which can be specified in particular according to the DSM-CC standard format, or can be based on flute and/or ALC (Asynchronous Layer Coding) and/or LCT (Layer Coding Transport), contains a plurality of scene data files SF1-SF4 which each contain one or more scene data object(s) for describing the same graphics scene and are transmitted in cyclical repetition to the receiver 3. In FIG. 1 the various scene data files SF1-SF4 are distributed over the circumference of a ring for clear representation, the arrow, which symbolizes the direction of rotation of the data carousel and the arrangement of the scene data files SF1-SF4 on the ring, indicates the temporal sequence for the cyclical transmission of the scene data files SF1-SF4 to the receiver. Therefore the second scene data file SF2 is transmitted after the first scene data file SF1, the third data scene file SF3 is transmitted after the second scene data file SF2, and the fourth scene data file SF4 is transmitted after the third scene data file SF3. Transmission of the first to fourth scene data files SF1-SF4 in this sequence is then repeated for a selectable period which is applicable to a presentation and/or decoding of the scene described in the scene data objects of the scene data files SF1-SF4.

It is known that, in particular when using FEC mechanisms (FEC=Forward Error Correction), this is an idealized representation and that the sequence of data files can only be interpreted by the receiver.

The data carousel of the transmitter 2 also contains an index file IF which, by way of example, is inserted here between the first scene data file 1 and the second scene data file 2 and is sent in this position in a temporal arrangement between the first scene data file 1 and the second scene data file 2.

The index file IF contains, in encoding in terms of data systems, information about a temporal arrangement of the scene data files SF1-SF4, i.e. a temporal arrangement for receiving the scene data files SF1-SF4 with a view to a graphical representation and/or decoding of the scene, and about a start time to graphically represent and/or decode the scene in the receiver 3.

FIG. 1 symbolically shows a time axis t in which the information, contained in the index file IF, for a temporal arrangement of the scene data files SF1-SF4 is shown. The temporal arrangement of the scene data files can be achieved for example by the time markers associated with the scene data files SF1-SF4. Therefore, encoded in the index file IF is the fact that the third scene data file SF3 should be received before the second scene data file SF2 in the temporal arrangement, the second scene data file SF2 should be received before the first scene data file SF1 in the temporal arrangement, and the first scene data file SF1 should be received before the fourth scene data file SF4 in the temporal arrangement for a presentation of the scene described in the scene data files SF1-SF4.

If the receiver 3 has received the index file IF, the receiver 3, for example if it is no longer possible to receive in full all scene data files SF1-SF4 by the start of graphical representation of the scene, can control receipt of the scene data files in a targeted manner, in the sequence of scene data files SF1-SF4 specified by the temporal arrangement of the index files IF, so the third scene data file SF3 is received and stored as the first data file, followed by the second scene data file SF2, followed by the first scene data file SF1 and followed by the fourth scene data file SF4. If a scene data file is to be re-used then this is possible without re-loading.

Even though FIG. 1 only shows a single index file IF in the data carousel of the transmitter 3, the intention is that the index file IF is transmitted to the receiver 3 during the same cycle of the data carousel, during which all scene data files SF1-SF4 are transmitted to the receiver once, with a greater frequency than the scene data files SF1-SF4, in order for the information, encoded in the index file IF, about the temporal arrangement of the scene data files SF1-SF4 to be present in the receiver 3 at a comparatively early point in time before the start time of the graphical representation and/or decoding of the scene. This can be achieved by sending the index file IF several times during the same cycle for transmitting the scene data files SF1-SF4 via the data carousel containing the scene data files SF1-SF4. Alternatively it is possible for the index file IF to be transmitted on a separate data carousel with a shorter cycle time compared with the data carousel containing the scene data files SF1-SF4.

Furthermore, the index file, in encoding in terms of data systems, contains information about which of the scene data files SF1-SF4 contains a root element for the directory structure, so this scene data file may be received and stored to obtain information about a directory structure contained in the scene data files in good time before the start time of the graphical representation of the scene. Furthermore, the index file contains, in encoding in terms of data systems, information about the time by which all scene data files SF1-SF4 should be cached in the receiver 3, so by the start time for graphical representation and/or decoding of the scene in the receiver, all scene data files SF1-SF4 can be received and stored in the receiver 3. The index file also contains, in encoding in terms of data systems, information about by which time the scene data files SF1-SF4 should be left in a rendering tree or shadow tree, so the scene data files SF1-SF4 can be stored in the receiver for later use, or can otherwise be deleted. Furthermore, the index file contains at least one identifier, which identifies at least one scene, allowing a scene to be indentified for external referencing, as well as scene data file references to external resources, so a scene does not have to be interpreted in order to determine which set of data files or data objects is required for the scene.

In the exemplary embodiment shown in FIG. 1 the index file IF is based on the FDT of a flute data transmission session, whereby it may advantageously be achieved that, compared with a known flute data carousel, the data carousel has to be checked less frequently following updates.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-15. (canceled)

16. A method for transmitting scene data files describing at least one scene by a data carousel from a transmitter to at least one receiver of a unidirectional data broadcast system, comprising:
transmitting, via the data carousel to the receiver, an index file used to at least one of graphically represent and decode the at least one scene, with a temporal arrangement of the scene data files being encoded in terms of data systems in the index file.

17. The method as claimed in claim 16, wherein a start time to at least one of graphically represent and decode the at least one scene to be at least one of represented and decoded being encoded in terms of data systems in the index file.

18. The method as claimed in claim 17, wherein encoded in terms of data systems in the index file is a root scene data file which contains a root element of a directory structure of the at least one scene.

19. The method as claimed in claim 18, wherein encoded in terms of data systems in the index file is a storage time by which all scene data files describing the at least one scene are to be cached in the receiver.

20. The method as claimed in claim 19, wherein encoded in terms of data systems in the index file is a tree time by which the scene data files describing the at least one scene are to be left in at least one of a rendering tree and a shadow tree used to at least one of graphically represent and decode the at least one scene.

21. The method as claimed in claim 20, wherein the index file is based on a File Delivery Table of a flute session.

22. The method as claimed in claim 21, wherein the index file contains at least one identifier by which the at least one scene is identified.

23. The method as claimed in claim 22, wherein the index file contains references of the scene data files to external resources.

24. A unidirectional data broadcast system transmitting scene data files describing at least one scene by a data carousel, comprising:
a transmitter transmitting, via the data carousel, an index file used to at least one of graphically represent and decode the at least one scene, with a temporal arrangement of the scene data files being encoded in terms of data systems in the index file; and
at least one receiver receiving via the data carousel the index file transmitted by said transmitter and at least one of graphically representing and decoding the at least one scene using the index file.

25. A transmitter of a unidirectional data broadcast system having at least one receiver and transmitting scene data files describing at least one scene by a data carousel, said transmitter comprising:
a processor executing machine-readable program code containing control commands that cause said transmitter to transmit, via the data carousel to the at least one receiver, an index file used to at least one of graphically represent and decode the at least one scene, with a temporal arrangement of the scene data files being encoded in terms of data systems in the index file.

26. A machine-readable medium embodying a computer program that when executed by a processor in a transmitter of a unidirectional data broadcast system having at least one receiver and transmitting scene data files describing at least one scene by a data carousel, causes the transmitter to carry out a method comprising:
transmitting, via the data carousel to the receiver, an index file used to at least one of graphically represent and decode the at least one scene, with a temporal arrangement of the scene data files being encoded in terms of data systems in the index file.

27. A receiver of a unidirectional data broadcast system having a transmitter transmitting scene data files describing at least one scene by a data carousel, said transmitter comprising:
a processor executing machine-readable program code containing control commands that cause said receiver to receive via the data carousel the index file transmitted by said transmitter and to at least one of graphically represent and decode the at least one scene using the index file.

28. A machine-readable medium embodying a computer program that when executed by a processor in a receiver of a unidirectional data broadcast system having a transmitter transmitting scene data files describing at least one scene by a data carousel, causes the receiver to perform a method comprising:
receiving via the data carousel the index file transmitted by the transmitter; and
at least one of graphically representing and decoding the at least one scene using the index file.
